(19) United States
(12) Patent Application Publication
(10) Pub. No.: US 2016/0179480 A1
(43) Pub. Date: Jun. 23, 2016

(54) COMPUTER APPLICATION DEVELOPMENT ASSISTANCE

(71) Applicant: ORANGE, Paris (FR)

(72) Inventors: Christine Ombrouck, Verson (FR); Francoise Deshayes, Herouville Saint Clair (FR)

(21) Appl. No.: 14/960,090

(22) Filed: Dec. 4, 2015

(30) Foreign Application Priority Data
Dec. 18, 2014 (FR) 1462821

(51) Int. Cl. G06F 9/44; G06F 3/0484; G06F 3/0482; H04L 29/06

(52) U.S. Cl. CPC G06F 8/34; H04L 63/08; G06F 3/04842; G06F 3/0482

(57) ABSTRACT

The invention relates to a method for obtaining assistance in the development of a software application, including the display on a screen of a graphical interface comprising at least one first graphical element and the triggering, following the detection of an action of a user relating to the first graphical element, of the execution of a software function associated with the first graphical element.

According to the invention, the method is suitable for displaying at least one second graphical element associated with the first graphical element, for detecting a user action relating to the second graphical element, for obtaining following this detection a text-based message containing at least one code instruction relating to the execution of the software function, and for displaying the text-based message.

The invention relates also to a method for providing assistance in the development of a software application.

The invention relates also to a terminal (T) and to a server (SV1) implementing the obtaining method and the provisioning method respectively.

The invention relates to the field of the development of computer applications, also called software or programs.

When a computer application is being developed, a programmer developer responsible for this development may need existing functionality blocks that have been developed beforehand, for example in third-party software.

These functionality blocks are integrated in computer applications and are rarely accessible. Documents, generally called “source code”, containing in text-based form the code instructions of these blocks, are sometimes available. These documents are documented to varying degrees and it is often difficult and time-consuming for a developer to understand how these blocks function.

Moreover, companies offer, generally for a payment, access to such software blocks.

“Access” must be understood here to mean the sending of a request commanding the execution of the chosen block and in return the reception of a response containing a result of the execution of this block.

More specifically, these functions can be queried via a programming interface, often denoted by the term API for “Application Programming Interface”.

These functions are offered by a software library or a web service, most often accompanied by a description which specifies how to interact with each function and more specifically the API associated with each function.

This description is a text file describing the functionalities of the function and the parameters to be transmitted to the API as well as the parameters received in a response to a request.

This description is in general very detailed. As a result, it is long and tedious for a programmer developer to rapidly understand, on the one hand, how to make use of the functionalities, and on the other hand, which are the parameters and formats of these parameters to be used to query a software block via the associated API and how to formulate a request to obtain a sought result.

One of the aims of the invention is to address deficiencies/drawbacks of the prior art and/or bring about improvements thereto.

To this end, the invention proposes a method for obtaining assistance in the development of a software application. This method includes a step for displaying on a screen a graphical interface comprising at least one first graphical element, a detection of an action of a user relating to said at least one first graphical element triggering an execution of a software function associated with said at least one first graphical element.

The method includes the following steps, implemented by a terminal:

the displaying of at least one second graphical element associated with said at least one first graphical element;

the detection of a user action relating to said at least one second graphical element;

following said detection, the obtaining of a text-based message containing at least one code instruction relating to the execution of said software function; and

the displaying of said text-based message.

By virtue of the second graphical element, it is thus possible for a user, who is a program developer, to obtain one or more code instructions relating to a software function associated with the first graphical element. The first graphical element provides for executing a software function. The second graphical element provides for obtaining one or more code instructions. The code instructions are received in the form of a text item displayed on a screen of the terminal, for example in a specific window. The user can thus retrieve the displayed text and insert it for example using “copy/paste” into a program being developed or use it to test a command, for example within a web browser, or more generally from a command interface.

The code instructions obtained also inform the user about the syntax to be used.

By virtue of the method of the invention, it is much easier for a developer to develop a program.

It is not necessary for a developer to study the full documentation describing the functionalities of the software function.

According to a particular embodiment of the obtaining method, the software function is executed by a first server and calls upon a predefined module hosted on a second server and said at least one code instruction can be executed by said module.

In this embodiment, the terminal calls up a software function installed on a first server. This software function calls up a predefined module hosted by a second server. This module is for example an API (Application Programmable Interface).

By virtue of the method, it is possible for a developer user to obtain the code instructions to directly query the module.

According to a particular embodiment, the obtaining method includes a step for sending to the first server a code instruction request, said request being formulated in a first language, and said text-based message is received in response to said request, said response is formulated in the first language, and said at least one code instruction is formulated in a second language.

The code instructions are formulated in a language suitable for the module. The developer can thus directly incorporate the code instructions into his/her program without having to convert them into another language.

Likewise, the developer can easily use another language to develop a software function calling the module.

According to a particular embodiment, the obtaining method includes:

a step for receiving a request for parameters containing at least one identifier of at least one parameter of said module;

a step for obtaining by means of a user interface of said terminal at least one value for said at least one parameter;

a step for sending to the first server a code instruction request, said request containing at least one value for said at least one parameter;

said text-based message is received in response to said request and said at least one code instruction is determined by said first server according to said at least one received value.

The insertion of parameter values provides for obtaining code instructions in which these parameters are inserted.

According to a particular embodiment of the obtaining method, the response additionally comprises a second text-based message containing a response to said command formulated by said module.

The method provides for obtaining a text type message containing an execution response supplied by the module.

The user can thus know the format of this response. The response gives the user information on the data present in the response. This allows a developer user to more easily exploit the response elements supplied by the module.

The invention relates also to a method for providing assistance in the development of a software application including the following steps, implemented by a first server suitable for executing a software function calling upon a predefined module hosted on a second server:

the reception, from a terminal, of a code instruction request;

the determination of a command containing at least one code instruction that can be executed by said module;

the construction of a text-based message containing said command;

the transmission of a response to said request containing the constructed text-based message.

Following a request from a terminal, a command containing code instructions is supplied to this terminal. The code instructions relate to the execution of a predefined software function.

According to a particular embodiment, the provisioning method includes a step for transmitting to said terminal a request for parameters containing at least one identifier of at least one parameter of said module, the code instruction request contains at least one value for said at least one parameter, and said command is determined according to said at least one received value.

According to a particular embodiment of the provisioning method, said command comprises at least one value of at least one additional parameter inserted by said first server.

Additional parameters can be necessary in a command transmitted to a module of the second server. These additional parameters correspond to values known by the first server and not necessarily known to the user or which the user has supplied previously.

Such a parameter is for example an item of data encrypted with a key, the key being accessible to the first server only if an authentication procedure has provided for authenticating the user.

According to a particular embodiment of the provisioning method, the code instruction request comprises at least one value defining at least one programming language parameter, and in which said command is formulated in said language.

The value defining at least one programming parameter allows a user to choose a programming language from among several languages accepted by the module.

According to a particular embodiment, the provisioning method includes a step for authenticating said user, and in which method the response does not contain said command and contains a message indicating an authentication problem if the authentication is not successful.

Thus, the code instruction or instructions are supplied only to authorized users, for example users having subscribed to a service for obtaining these code instructions.

The invention relates also to a terminal including a display module for displaying on a screen a graphical interface comprising at least one first graphical element, a module for detecting an action by a user, a module for triggering an execution of a software function associated with said at least one first graphical element in the event that a user action relating to said at least one first graphical element is detected.

The display module of the terminal is configured to display at least one second graphical element associated with said at least one first graphical element and the terminal includes an obtaining module to obtain, following a detection of a user action relating to said at least one second graphical element, a text-based message containing at least one code instruction relating to the execution of said software function. The display module of the terminal is configured to display said text-based message.

The invention relates also to a first server suitable for executing a software function calling upon a predefined module hosted on a second server. The first server includes:

a module for receiving from a terminal a code instruction request;

a module for determining a command containing at least one code instruction that can be executed by said module;

a module for constructing a text-based message containing said command;

a module for transmitting a response to said request containing the constructed text-based message.

According to a preferred implementation, the various steps of the obtaining method, respectively of the provisioning method, according to the invention are implemented by a computer program or software.

The invention thus relates to a program or software, likely to be executed by a computer or by a data processor, this software/program including instructions to command the execution of the steps of an assistance-obtaining method or of an assistance-provisioning method. These instructions are intended to be stored in a memory of a computer-based device, loaded and then executed by a processor of this computer-based device.

This software/program can use any programming language and be in the form of source code, object code or a code intermediate between source code and object code, such as in a partially compiled form or in any other desirable form.

The computer-based device can be implemented by one or more physically separate machines and exhibits overall the architecture of a computer, including components of such an architecture: data memory or memories, processor(s), communication bus(es), hardware interface(s) for connecting this computer-based device to a network or to other equipment, user interface(s), etc.

The invention relates also to a data medium readable by a data processor, and including instructions of a program as mentioned above. The data medium can be any entity or device capable of storing the program.

Other features and advantages of the present invention will become clear in the following description of an embodiment given by way of a non-limiting example, with reference to the accompanying drawings in which:

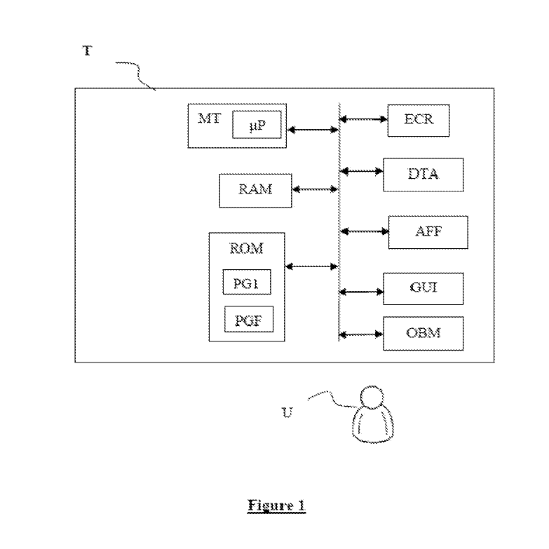

FIG. 1 is a block diagram illustrating a terminal according to an embodiment of the invention,

FIG. 2 is a flow chart illustrating the various steps of an obtaining method and a provisioning method according to a first embodiment of the invention,

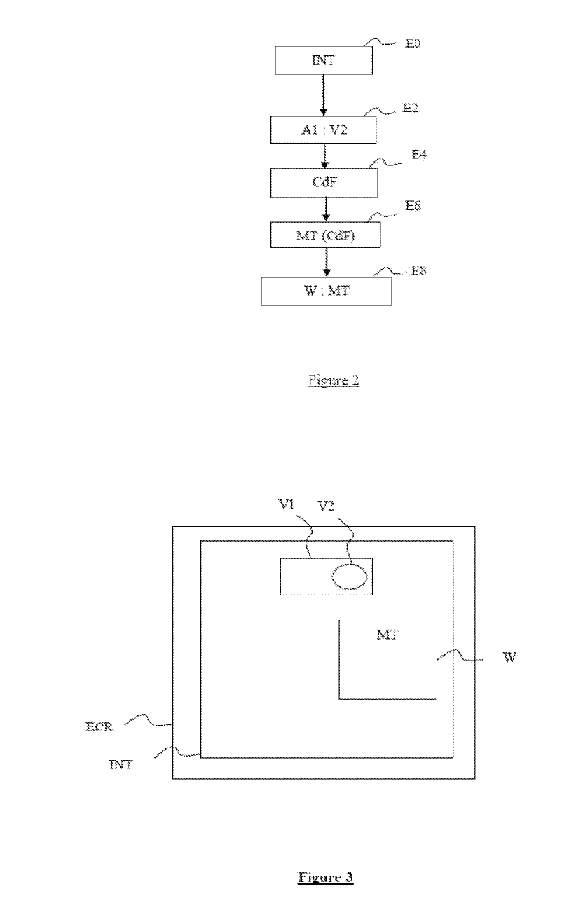

FIG. 3 illustrates a first example graphical interface,

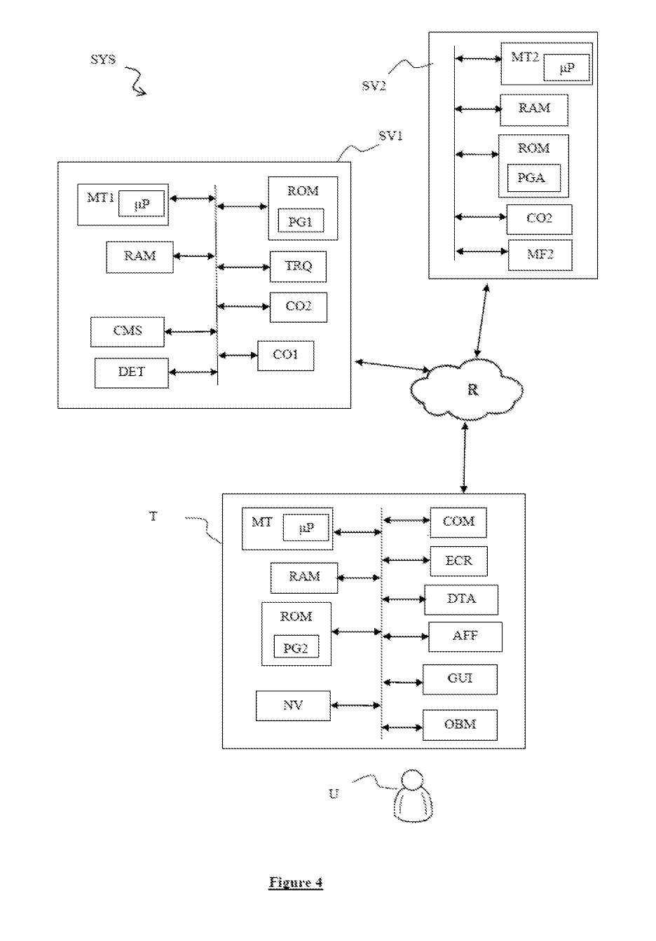

FIG. 4 is a block diagram illustrating a system according to an embodiment of the invention,

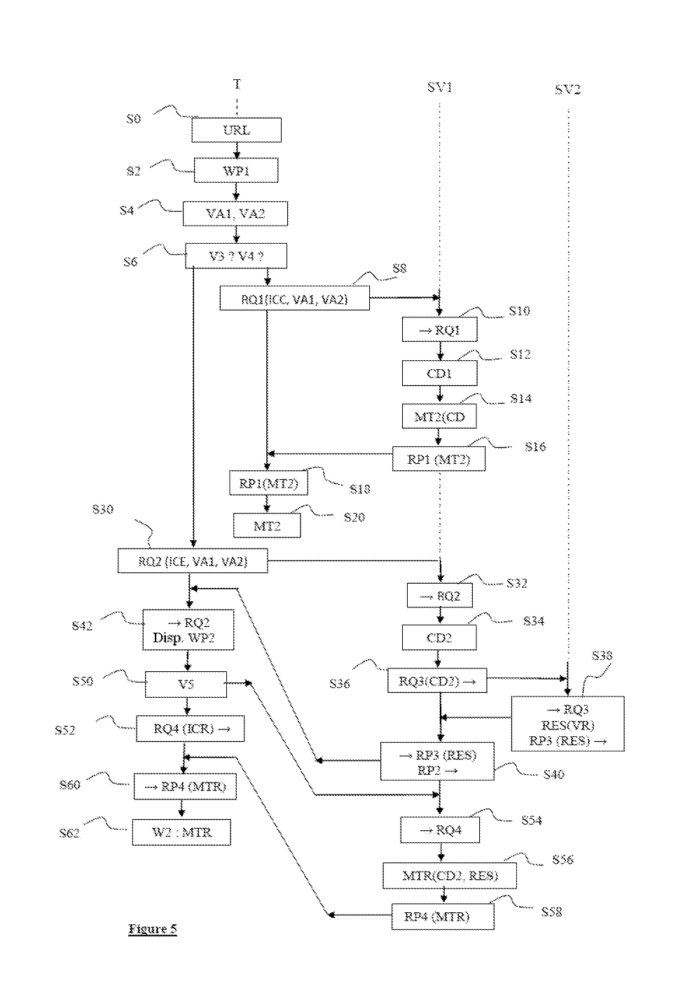

FIG. 5 is a flow chart illustrating the steps of an obtaining method and of a provisioning method according to a second embodiment of the invention,

FIGS. 6, 7 and 8 illustrate example graphical interfaces.

The invention is implemented by means of software and/or hardware components. In this regard, the term “module” can be in this document a software component or a hardware component, or an assembly of hardware and/or software components, suitable for implementing a function or a set of functions, according to that which is described below for the module concerned.

A software component corresponds to one or more computer programs, one or more sub-programs of a program, or more generally to any element of a program or a software item. Such a software component is stored in memory, then loaded and executed by a data processor of a physical entity (terminal, server, gateway, set-top box, router, etc) and is likely to access the hardware resources of this physical entity (memories, recording media, communication buses, electronic input/output boards, user interfaces, etc).

In the same way, a hardware component corresponds to any element of a hardware assembly. It can be a programmable hardware component or with an integrated processor for executing software, for example an integrated circuit, a chip card, an electronic board for executing firmware, etc.

An embodiment of an obtaining method and of a provisioning method will now be described with reference to FIGS. 1 to 3.

FIG. 1 represents a user terminal T.

The terminal T is for example a PC (Personal Computer).

Alternatively, the terminal T is a mobile phone or a PDA (Personal Digital Assistant).

The terminal T includes in a known way, notably a processing unit MT equipped with a microprocessor, a read-only memory ROM, a random-access memory RAM and a screen ECR.

The terminal T can include, conventionally and non-exhaustively, the following elements: a microphone, a speaker, a disk drive, a keyboard, a display screen, a storage means, etc.

The terminal T also includes a display module AFF, a user interface module GUI, a user action detection module DTA and a message obtaining module OBM.

The read-only memory ROM includes registers storing a computer program PG1 containing program instructions suitable for implementing an obtaining method according to one embodiment of the invention described later with reference to FIG. 2.

The read-only memory ROM also includes registers storing a computer program PGF containing program instructions suitable for implementing a software function F1.

The program instructions represent code instructions in the sense of the invention.

Alternatively, the computer program PGF is hosted on a remote server accessible by the terminal T.

An embodiment of an obtaining method and of a provisioning method, implemented in the terminal T, will now be described with reference to FIG. 2.

During a preliminary step E0, the processing module MT of the terminal T commands the displaying, by the display module AFF, of a graphical interface INT on the screen ECR of the terminal T.

The graphical interface INT is typically a window displayed on the screen ECR.

The graphical interface INT comprises a first graphical element V1 and a second graphical element V2 associated with the first graphical element V1.

FIG. 3 represents the graphical interface INT and the thumbnails V1 and V2.

The second graphical element is in this case overlaid on the first graphical element V1. This overlaying provides for highlighting the fact that the second graphical element V2 is associated with the first graphical element V1.

Other means for highlighting the association of the two thumbnails can be implemented, such as for example a juxtapositioning of the two thumbnails, the displaying of an arrow between the two thumbnails, etc.

A user U of the terminal T can by means of the user interface module GUI, for example a computer mouse, click in the area of the screen representing the graphical element V1 or in the area of the screen representing the graphical element V2.

An action by the user relating to the graphical element V1 triggers the execution of the software function F1.

Conventionally, the execution of the software function F1 provides for example for obtaining a result which is for example displayed on the screen ECR.

During a step E2, the detection module DTA of the terminal T detects an action A1 by the user of the terminal T relating to the second graphical element V2.

Action A1 is for example a click or a double-click performed via a computer mouse connected to the terminal T, in the area of the screen ECR representing the second graphical element V2.

Step E2 is followed by a step E4 during which the obtaining module OBM of the terminal T accesses the memory ROM, and more particularly an area of the memory where the code instructions of the function F1, i.e. the code instructions of the program PGF, are stored, and obtains the code instructions CdF of the function F1.

Step E4 is followed by a step E6 during which the obtaining module OBM includes all or some of the obtained code instructions CdF in a text-based message MT.

The obtaining module OBM of the terminal T thus obtains a text-based message MT containing at least one code instruction relating to the execution of the software function F1.

During a step E8, the display module AFF of the terminal T displays the obtained text-based message MT on the screen ECR.

The text-based message MT is for example displayed in an additional window W of the graphical interface INT.

FIG. 3 also illustrates the window W containing the text-based message MT.

A second embodiment of an obtaining method and of a provisioning method will now be described with reference to FIGS. 4 to 8.

With reference to FIG. 4, a system SYS comprises a user terminal T, a first server SV1 and a second server SV2.

The terminal T is for example a PC (Personal Computer).

Alternatively, the terminal T is a mobile phone or a PDA (Personal Digital Assistant).

More generally, the terminal T is an item of equipment suitable for accessing a communication network R by means of a web browser of said equipment.

In a known way, a web browser is an item of software designed to consult the World Wide Web.

The terminal T includes in a known way, notably a processing unit MT equipped with a microprocessor, a read-only memory ROM, a random-access memory RAM and a display screen ECR.

The terminal T can include, conventionally and non-exhaustively, the following elements: a microphone, a speaker, a disk drive, a keyboard, a storage means, etc.

The terminal T also includes a web browser NV, a display module AFF, a user interface module GUI, a user action detection module DTA, a message obtaining module OBM and a communication module COM suitable for communicating with the first server SV1 via the communication network R.

The read-only memory ROM includes registers storing a computer program PG2 containing program instructions suitable for implementing an obtaining method according to one embodiment of the invention described later with reference to FIG. 5.

The first server SV1 and the second server SV2 are computer-based equipment exhibiting the structure of a computer. They are able to communicate between each other via the communication network R.

Alternatively, the first server SV1 and the second server SV2 communicate with each other via a dedicated communication link, for example a communication link of a private network or a wired link.

The first server SV1 includes in a known way, notably a processing unit MT1 equipped with a microprocessor, a read-only memory ROM and a random-access memory RAM.

The first server SV1 also includes a communication module CO1 to communicate with the terminal T, for example via the communication network R and a communication module CO2 to communicate with the second server SV2.

The first server SV1 also includes a request processing module TRQ, a determination module DET and a message construction module CMS.

The second server SV2 includes in a known way, notably a processing unit MT2 equipped with a microprocessor, a read-only memory ROM and a random-access memory RAM.

The second server S2 also includes a communication module CO2 to communicate with the first server SV1.

The second server SV2 also includes a module MF2 suitable for executing a software function F2.

The read-only memory ROM of the second server SV2 includes registers storing a computer program PGA containing code instructions suitable for implementing a software function F2.

An embodiment of an obtaining method and of a provisioning method, implemented in the system SYS, will now be described with reference to FIG. 5.

During a step S0, a user U of the terminal T accesses the web browser NV of this terminal and enters an address of the first server SV1.

More specifically, the address entered is typically a predefined URL (Uniform Resource Locator) of a web service WS1 hosted on the first server SV1.

The terminal T thus obtains, during a step S2, a web page WP1 supplied by the first server SV1.

The web page WP1 is displayed on the screen ECR of the terminal T.

The displaying of the page WP1 comprises here the displaying of a graphical interface INT2.

The input interface INT2 is typically an input form.

FIG. 6 illustrates an example graphical interface INT2.

The graphical interface INT2 allows the user U to enter parameter values and to command the execution of one or more functions using these parameters.

To this end, the graphical interface INT2 contains one or more areas for inputting parameter values.

For example, a first area Z1 allows the entry of a value VA1 of a first parameter P1 and a second area Z2 allows the entry of a value VA2 of a second parameter P2.

Alternatively, the form does not offer a parameter entry or the number of parameters to be entered is less than or greater than two.

The graphical interface INT2 also comprises a first graphical element V3 and a second graphical element V4 associated with the first graphical element V3.

The first graphical element V3 allows the user to command the execution of a software function FL of the web service WS1 and to obtain a result of the execution of this function.

In the embodiment described, when it is being executed, the software function FL calls upon a software module MF2 hosted on the second server SV2. The module MF2 is suitable for executing a software function F2 that can be queried via a programming interface (API).

During a step S4, the user enters a value VA1 for the parameter P1 and a value VA2 for the parameter P2.

In a known way, the values requested can be of various types (digital value, text, etc), of predetermined format (length, etc), chosen from a predefined dropdown list, etc and a check is performed on the conformity of the values entered.

During a step S6, the user U clicks on one of the thumbnails V3 or V4 and the detection module DTA of the terminal T detects a user action relating to the graphical element V3 or to the graphical element V4.

If during step S6 the detection module DTA detects a user action relating to the second graphical element V4, step S6 is followed by a step S8 during which a request RQ1 containing a code command CdC is sent by the communication module COM of the terminal T to the first server SV1.

The request RQ1 represents a code instruction request.

The code command CdC comprises an identifier ICC of the command CdC and the values VA1 and VA2 entered during step S4.

The request RQ1 is in this embodiment an HTTP (HyperText Transfer Protocol) request.

The code command CdC is formulated in a language LP1. The language LP1 is a known language of the first server SV1 and can be interpreted by the latter.

The language LP1 represents a first language in the sense of the invention.

The request RQ1 containing the code command CdC is received by the first communication module CO1 of the first server SV1 during a step S10.

Then, during a step S12, the determination module DET of the first server SV1 determines a code instruction command CD1 as a function of the request RQ1 and of the values VA1 and VA2 received.

The command CD1 represents in this case a code instruction. It is formulated in a predefined programming language LP2. It can be executed by the second server SV2.

The language LP2 is for example the language Curl, the language JSON (JavaScript Object Notation), etc.

The language LP2 represents a second language in the sense of the invention.

The command CD1 contains as parameters the values VA1 and VA2.

Alternatively, the command CD1 also comprises one or more values of one or more parameters inserted by the determination module DET of the first server SV1.

An inserted parameter is for example a data item encrypted with a key of the user U which is shared by the first server SV1 and the second server SV2. The key of the user U is for example saved in a memory accessible by the first server SV1 and obtained by the first server SV1 after a phase for authenticating the user U.

Step S12 is followed by a step S14, during which the message construction module CMS of the first server SV1 constructs a text type message MT2 containing the code instruction command CD1.

Then, during a step S16, the communication module CO2 of the first server SV1 transmits to the terminal T a response RP1 to the request RQ1.

The response RP1 contains the text-based message MT2.

The “text” type message MT2 is encapsulated in the response RP1. The response RP1 is of HTML type. It contains a web page or a part of an HTML page.

The response RP1 is received by the terminal T, and more specifically by the web browser of the terminal T, via the communication module COM, during a step S18.

During a step S20, the display module AFF of the terminal T displays an additional window W1 containing the text message MT2, i.e. the code instruction command CD1.

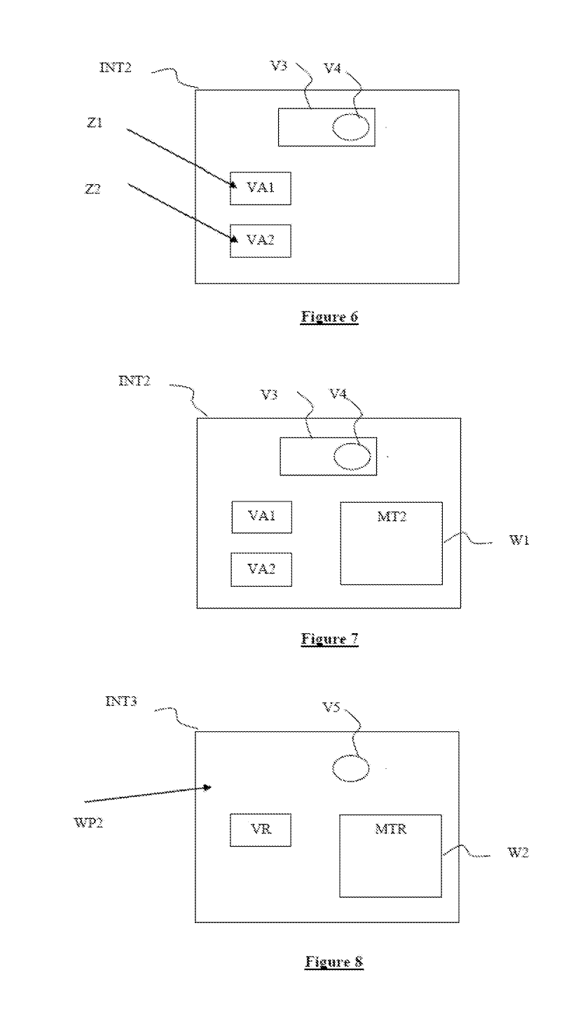

FIG. 7 illustrates the graphical interface INT2 in which the window W1 containing the message MT2 is displayed.

The user U can then retrieve the displayed content, for example by a “copy/paste” operation and insert it into a software application being developed.

If, during step S6, the detection module DTA of the terminal T detects an action relating to the first graphical element V3, step S6 is followed by a step S30, during which a request RQ2 containing an execution command CdE is sent to the first server SV1.

The execution command CdE comprises an identifier ICE of the command CdE and the values VA1 and VA2 entered during step S4. The command CdE is formulated in the first language LP1.

The request RQ2 is received by the first communication module CO1 of the first server S1 during a step S32.

Then, during a step S34, the determination module DET of the first server SV1 determines a code instruction command CD2 as a function of the request RQ2, i.e. as a function of the execution command CdE and of the values VA1 and VA2 received.

Insofar as the values VA1 and VA2 have not been modified by the user U, the command CD2 is the command CD1 constructed during step S12.

The command CD2 is formulated in the second language LP2.

The command CD2 is saved in a memory, for example a temporary memory, of the first server SV1.

Step S34 is followed by a step S36 during which the second communication module CO2 of the first server SV1 transmits to the second server SV2 a request RQ3 containing the command CD2 determined during step S34.

Then, during a step S38, the second server SV2 receives the request RQ3 via its communication module CO2, processes this request RQ3 and transmits a response RP3 to the first server SV1.

The processing of the request RQ3 by the second server SV2 comprises the execution of the command CD2 by the computer program PGA.

In other words, the module MF2 of the second server SV2 executes the software function F2 and determines an execution result RES.

The result RES is formulated in the same programming language LP2 as the command CD2. The result RES contains for example a status, or one or more parameter values.

It contains for example a value VR of a parameter P3.

The response RP3 to the request RQ3 contains the result RES.

Step S38 is followed by a step S40 during which the first server SV1 receives the response RP3, converts the response RP3 into a response RP2 and transmits, to the terminal T, the response RP2 to the request RQ2.

The conversion of the response RP3 into a response RP2 notably comprises a change of format. The response RP2 is in this case of HTML type.

The response RP2 is in the embodiment described, a web page WP2 containing on the one hand the value VR and on the other hand a graphical element V5.

Step S40 also comprises the saving, into a memory accessible by the first server SV1, of the result RES contained in the response RP3.

During a step S42, following the reception of the response RP2, the terminal T receives the response RP2 and displays a second web page WP2 containing the response RP2, and as a consequence the value VR.

The displayed web page WP2 also includes the graphical element V5.

The graphical element V5 is a graphical element enabling the user to request that the code instructions of the result RES be obtained.

A message indicating the purpose of the graphical element V5 is for example indicated in the web page WP2.

FIG. 8 illustrates a graphical interface INT3 containing the web page WP2.

Alternatively, the value VR and the graphical element V5 are displayed in the web page WP1 or in an additional window of the web page WP1.

During a step S50, the detection module DTA of the terminal T detects a user action relating to the graphical element VS.

Step S50 is followed by a step S52 during which a request RQ4 containing a code command CdR is sent by the communication module COM of the terminal T to the first server SV1.

The code command CdR is formulated in the first language LP1.

The code command CdR comprises an identifier ICR of the command CdR.

The request RQ4 containing the code command CdR is received by the first communication module CO1 of the first server SV1 during a step S54.

Then, during a step S56, the message construction module CMS of the first server SV1 determines a text-based message MTR containing on the one hand the code instruction command

CD2 saved during step S34 and on the other hand the result RES obtained by the execution of the command CD2 and saved during step S40.

Then, during a step S58, the request processing module TRQ of the first server SV1 constructs a response RP4 to the request RQ4 and commands the transmission of the response RP4 by the communication module CO2 of the first server SV1 intended for the terminal T.

The response RP4 contains the text-based message MTR.

The response RP4 is of HTML type.

The response RP4 is received by the terminal T, and more specifically by the web browser of the terminal T, via the communication module COM, during a step S60.

During a step S62, the display module AFF of the terminal T displays in the graphical interface INT2, an additional window W2 containing the text message MTR.

FIG. 8 illustrates the graphical interface 1NT3 in which the window W2 containing the message MTR is displayed.

The user U can then retrieve the content of the displayed message MTR, for example by a “copy/paste” operation and insert it into a software application being developed.

Steps S0, S2, S4, S8, S18, S20, S30, S42 to S52, S60 and S62, implemented by the terminal T, represent the steps of the obtaining method.

Steps S10, S12, S14, S16, S32, S34, S36, S40, S54, S56 and S58, implemented by the first server SV1, represent the steps of the provisioning method.

1. Method for obtaining assistance in the development of a software application, the method including a step (E0, S2) for displaying on a screen (ECR) a graphical interface (INT, INT2) comprising at least one first graphical element (V1, V3), a detection (E2, S6) of an action of a user relating to said at least one first graphical element triggering an execution of a software function (F1, FL) associated with said at least one first graphical element,
characterized in that it includes the following steps, implemented by a terminal (T):
the displaying (E0, S2) of at least one second graphical element (V2, V4) associated with said at least one first graphical element;
the detection (E2, S6) of a user action relating to said at least one second graphical element;
following said detection, the obtaining (E6, S18) of a text-based message (MT, MT2) containing at least one code instruction relating to the execution of said software function;
the displaying (E8, S20) of said text-based message.

2. Obtaining method according to claim 1, in which said software function is executed by a first server (SV1) and calls upon a predefined module (MF2) hosted on a second server (SV2) and said at least one code instruction can be executed by said module.

3. Obtaining method according to claim 2, including
a step for sending to the first server a code instruction request, said request being formulated in a first language;
and in which said text-based message is received in a response to said request, said response is formulated in the first language and said at least one code instruction is formulated in a second language.

4. Obtaining method according to claim 2, including
a step for receiving a request for parameters containing at least one identifier of at least one parameter of said module;
a step for obtaining by means of a user interface of said terminal at least one value for said at least one parameter;
a step for sending to the first server a code instruction request, said request containing at least one value for said at least one parameter;
and in which said text-based message is received in response to said request and said at least one code instruction is determined by said first server according to said at least one received value.

5. Obtaining method according to claim 3, in which said response additionally comprises a second text-based message containing a response to said command formulated by said module.

6. Method for providing assistance in the development of a software application characterized in that it includes the following steps, implemented by a first server (SV1) suitable for executing a software function (FL) calling upon a predefined module (MF2) hosted on a second server (SV2):
the reception (S10), from a terminal (T), of a code instruction request (RQ1);
the determination (S12) of a command (CD1) containing at least one code instruction that can be executed by said module;
the construction (S14) of a text-based message (MT2) containing said command;
the transmission (S16) of a response (RP1) to said request containing the constructed text-based message (MT2).

7. Provisioning method according to claim 6, including a step for transmitting to said terminal a request for parameters containing at least one identifier of at least one parameter of said module;
in which the code instruction request contains at least one value for said at least one parameter; and
in which said command is determined according to said at least one received value.

8. Provisioning method according to claim 6, in which said command comprises at least one value of at least one additional parameter inserted by said first server.

9. Provisioning method according to claim 6, in which the code instruction request comprises at least one value defining at least one programming language parameter, and in which said command is formulated in said language.

10. Provisioning method according to claim 6, including a step for authenticating said user, and in which the response does not contain said command and contains a message indicating an authentication problem if the authentication is not successful.

11. Terminal (T) including a display module (AFF) for displaying on a screen (ECR) a graphical interface (INT, INT2) comprising at least one first graphical element (V1, V3), a module for detecting an action by a user (DTA) triggering an execution of a software function (F1, FL) associated with said at least one first graphical element, characterized in that:
the display module (AFF) is configured to display at least one second graphical element (V2, V4) associated with said at least one first graphical element;
the terminal includes an obtaining module (OBM) to obtain, following a detection of a user action relating to said at least one second graphical element, a text-based message (MT, MT2) containing at least one code instruction relating to the execution of said software function; and
the display module (AFF) is configured to display said text-based message.

12. Server (SV1) suitable for executing a software function (FL) calling upon a predefined module (MF2) hosted on a second server (SV2), characterized in that it includes:
a module (CO1) for receiving a code instruction request (RQ1) from a terminal (T);
a module (DET) for determining a command (CD1) containing at least one code instruction that can be executed by said module;
a module (CMS) for constructing a text-based message (MT2) containing said command; and
a module (CO1) for transmitting a response to said request containing the constructed text-based message.

13. Obtaining method according to claim 4, in which said response additionally comprises a second text-based message containing a response to said command formulated by said module.

14. Provisioning method according to claim 7, in which said command comprises at least one value of at least one additional parameter inserted by said first server.

15. Provisioning method according to claim 7, in which the code instruction request comprises at least one value defining at least one programming language parameter, and in which said command is formulated in said language.

16. Provisioning method according to claim 8, in which the code instruction request comprises at least one value defining at least one programming language parameter, and in which said command is formulated in said language.

17. Provisioning method according to claim 7, including a step for authenticating said user, and in which the response does not contain said command and contains a message indicating an authentication problem if the authentication is not successful.

18. Provisioning method according to claim 8, including a step for authenticating said user, and in which the response does not contain said command and contains a message indicating an authentication problem if the authentication is not successful.

19. Provisioning method according to claim 9, including a step for authenticating said user, and in which the response does not contain said command and contains a message indicating an authentication problem if the authentication is not successful.
